(19) United States
(12) Patent Application Publication
(10) Pub. No.: US 2023/0070626 A1
(43) Pub. Date: Mar. 9, 2023

(54) ALL-SOLID-STATE BATTERY WITH A PROTECTIVE LAYER INCLUDING A METAL SULFIDE AND A METHOD OF MANUFACTURING SAME

(71) Applicants: HYUNDAI MOTOR COMPANY, Seoul (KR); KIA CORPORATION, Seoul (KR)

(72) Inventors: Seung Ho Choi, Hanam-si (KR); Ga Hyeon Im, Gwangju (KR); Sang Heon Lee, Yongin-si (KR); Yun Sung Kim, Seoul (KR)

(73) Assignees: HYUNDAI MOTOR COMPANY, Seoul (KR); KIA CORPORATION, Seoul (KR)

(21) Appl. No.: 17/939,714

(22) Filed: Sep. 7, 2022

(30) Foreign Application Priority Data
Sep. 9, 2021 (KR) 10-2021-0120153

(51) Int. Cl. H01M 4/62; H01M 10/058; H01M 10/0525

(52) U.S. Cl. CPC H01M 4/626; H01M 4/623; H01M 10/058; H01M 10/0525

(57) ABSTRACT

An all-solid-state battery and a method of manufacturing such a battery are disclosed. The battery includes a protective layer including a metal sulfide and thus is capable of suppressing the growth of lithium dendrites and is improved in performance aspects such as lifespan, charge/discharge rate, and the like.

### CROSS-REFERENCE TO RELATED APPLICATION

This application claims under 35 U.S.C. § 119(a) the benefit of priority to Korean Patent Application No. 10-2021-0120153, filed on Sep. 9, 2021, the entire contents of which are incorporated herein by reference.

### BACKGROUND

### (a) Technical Field

The present disclosure relates to an all-solid-state battery and methods of manufacturing the same. The battery includes a protective layer including a metal sulfide and thus is capable of suppressing the growth of lithium dendrites and is improved in performance aspects such as lifespan, charge/discharge rate, and the like.

### (b) Background Art

An excellent energy storage device is needed for construction of an eco-friendly energy system. Lithium-ion batteries are most commonly used due to the high energy density, stable power output, and long lifespan thereof. However, because the organic liquid electrolyte used in lithium-ion batteries is flammable, there is the risk of fire.

All-solid-state batteries are nonflammable and thus safe because all components that replace liquid electrolytes are solid. Moreover, due to application of a solid electrolyte used in all-solid-state batteries to a lithium metal anode or an anodeless current collector, energy density may be drastically improved.

An anodeless all-solid-state battery is based on the principle of depositing lithium metal on the surface of an anode current collector without using an anode active material, unlike conventional lithium secondary batteries. An anodeless, all-solid-state battery includes a cathode layer, a solid electrolyte layer, and an anode current collector. While charging, lithium ions move from the cathode layer to the anode current collector, and the lithium ions are deposited on the anode current collector as the form of lithium metal through an electrochemical reduction reaction with electrons from the anode current collector. The anodeless, all-solid-state battery is capable of increasing energy density due to the spatial advantage and of reducing processing costs for manufacturing the battery.

However, if only the anode current collector is used, lithium is not uniformly deposited and stored because of the non-uniform interface between the solid electrolyte layer and the anode current collector. Specifically, lithium deposition starts only in the space where the solid electrolyte layer and the anode current collector are in physical contact with each other. As a result, lithium dendrites may penetrate the solid electrolyte layer and cause a short circuit of the battery.

In order to solve the above problem, it is necessary to apply a protective layer capable of inducing uniform deposition of lithium ions while filling the interfacial space between the solid electrolyte layer and the anode current collector. The protective layer is physically and chemically nonreactive with the solid electrolyte and has an ability to conduct lithium ions.

### SUMMARY OF THE DISCLOSURE

An object of the present disclosure is to provide an all-solid-state battery capable of suppressing the formation of lithium dendrites.

Another object is to provide an all-solid-state battery having improved lifespan, charge/discharge rate, and the like.

Still another object is to provide an all-solid-state battery capable of operating across a wide temperature range from low to high temperatures.

The objects of the present disclosure are not limited to the foregoing. The objects of the present disclosure are clarified through the following description and realized by the battery embodiments and manufacturing methods described in the claims and combinations thereof.

An embodiment of the present disclosure provides an all-solid-state battery including a cathode layer, an anode current collector, a solid electrolyte layer positioned between the cathode layer and the anode current collector, and a protective layer positioned between the anode current collector and the solid electrolyte layer and including a metal.

The protective layer may include a metal sulfide incapable of alloying with lithium and the metal capable of alloying with lithium.

The metal sulfide may include a compound represented by Chemical Formula 1 below.

[Chemical Formula 1]

MSₓ (1)

Here, M includes molybdenum (Mo), tungsten (W), chromium (Cr), vanadium (V), titanium (Ti), manganese (Mn), iron (Fe), cobalt (Co), nickel (Ni), copper (Cu), or any combination thereof, and x is an integer in a range of 1 to 3.

The average particle diameter (D50) of the metal sulfide may range from 10 nm to 500 nm.

The metal may include silver (Ag), tin (Sn), zinc (Zn), magnesium (Mg), indium (In), bismuth (Bi), germanium (Ge), silicon (Si), or any combination thereof.

The average particle diameter (D50) of the metal may range from 10 nm to 500 nm.

The protective layer may include 20 wt. % to 90 wt. % of the metal sulfide and 10 wt. % to 80 wt. % of the metal.

The protective layer may further include a binder including butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), polyethylene oxide (PEO), or any combination thereof.

The protective layer may include 1 part by weight to 20 parts by weight of the binder based on 100 parts by weight of the metal sulfide and the metal.

The thickness of the protective layer may range from 0.1 μm to 20 μm.

Another embodiment of the present disclosure provides a method of manufacturing an all-solid-state battery. The method includes preparing a slurry including a metal sulfide incapable of alloying with lithium, a metal capable of alloying with lithium, and a solvent; forming a protective layer by applying the slurry on an anode current collector; forming a solid electrolyte layer on the protective layer; and forming a cathode layer on the solid electrolyte layer.

The solvent may include at least one of N-methyl pyrrolidone (NMP), water, ethanol, isopropanol, dimethyl sulfoxide (DMSO), or any combination thereof.

The slurry may further include a binder. The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), polyethylene oxide (PEO), or any combination thereof.

The slurry may include 1 part by weight to 20 parts by weight of the binder based on 100 parts by weight of the metal sulfide and the metal.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure.

FIG. 1 shows a cross-sectional view of an example of an all-solid-state battery according to the present disclosure;

FIG. 2 shows a cross-sectional view of the all-solid-state battery of FIG. 1, which is charged;

FIG. 3A shows a first charge/discharge graph of a half-cell according to a Comparative Example;

FIG. 3B shows the results of evaluation of the lifespan of the half-cell according to a Comparative Example;

FIG. 4 shows a scanning electron microscope (SEM) image of the surface of a protective layer of Example 1;

FIG. 5A shows a first charge/discharge graph of a half-cell according to Example 1;

FIG. 5B shows the results of evaluation of the lifespan of the half-cell according to Example 1;

FIG. 6A shows a first charge/discharge graph of a half-cell according to Example 2;

FIG. 6B shows the results of evaluation of the lifespan of the half-cell according to Example 2;

FIG. 7A shows an electron microscope image of the cross section of the half-cell according to Example 2 after being charged the first time;

FIG. 7B shows the results of energy dispersive X-ray spectroscopy (EDS) of the cross section of FIG. 7A; and

FIG. 8 shows the results of evaluation of the lifespan of a half-cell according to Example 3.

### DETAILED DESCRIPTION

The above and other objects, features, and advantages of the present disclosure are more clearly understood from the following embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those of ordinary skill in the art.

Throughout the drawings, the same reference numerals refer to the same or like elements. For the sake of clarity of the present disclosure, the dimensions of structures are depicted as being larger than the actual sizes thereof. Although terms such as “first,” “second,” etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

The terms “comprise”, “include”, “have”, etc., when used in this specification, specify the presence of stated features, integers, acts, operations, elements, components, or combinations thereof, but do not preclude the presence or addition of one or more other features, integers, acts, operations, elements, components, or combinations thereof. Also, when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

FIG. 1 shows a cross-sectional view of an example of an all-solid-state battery according to the present disclosure. With reference thereto, the all-solid-state battery may include a cathode layer 10, an anode current collector 20, a solid electrolyte layer interposed between the cathode layer 10 and the anode current collector 20, and a protective layer 40 interposed between the anode current collector 20 and the solid electrolyte layer 30.

The cathode layer 10 may include a cathode active material, a solid electrolyte, a conductive material, a binder, and the like.

The cathode active material may include an oxide active material or a sulfide active material.

The oxide active material may include a rock-salt-layer-type active material such as LiCoO₂, LiMnO₂, LiNiO₂, LiVO₂, Li₁₊ₓNi_{1/3}Co_{1/3}Mn_{1/3}O₂, or the like, a spinel-type active material such as LiMn₂O₄, Li(Ni_{0.5}Mn_{1.5})O₄, or the like, an inverse-spinel-type active material such as LiNiVO₄, LiCoVO₄, or the like, an olivine-type active material such as LiFePO₄, LiMnPO₄, LiCoPO₄, LiNiPO₄, or the like, a silicon-containing active material such as Li₂FeSiO₄, Li₂MnSiO₄, or the like, a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (M being at least one of aluminum (Al), magnesium (Mg), cobalt (Co), iron (Fe), nickel (Ni), and zinc (Zn), 0<x+y<2), or lithium titanate such as Li₄Ti₅O₁₂, or the like.

The sulfide active material may include copper chevrel, iron sulfide, cobalt sulfide, nickel sulfide, etc.

The cathode active material may be coated with an oxide such as LiNbO₃. The oxide is configured to prevent a side reaction between the cathode active material and the solid electrolyte by preventing physical contact therebetween.

The solid electrolyte may include an oxide-based solid electrolyte or a sulfide-based solid electrolyte. In certain examples, the sulfide-based solid electrolyte has a high lithium-ion conductivity. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers and Z is any one of Ge, Zn, and Ga), Li₂S—GeS₂, Li₂S—SiS₂—Li₃PO₄, Li₂S—SiS₂—LiₓMO_{y} (in which x and y are positive numbers and M is any one of P, Si, Ge, B, Al, Ga, and In), Li₁₀GeP₂S₁₂, and the like.

Examples of the conductive material may include carbon black, conductive graphite, ethylene black, graphene, and the like.

Examples of the binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), polyethylene oxide (PEO), and the like.

A cathode current collector 11 may be disposed on the cathode layer 10.

The cathode current collector 11 may be an electrically conductive plate-type substrate and may include aluminum foil.

The anode current collector 20 may be an electrically conductive plate-type substrate. The anode current collector 20 may include at least one of nickel (Ni), stainless steel (SUS), or any combination thereof.

The anode current collector 20 may be a high-density metal thin film having porosity of less than 1%.

The anode current collector 20 may have a thickness of 1 μm to 20 μm, or 5 μm to 15 μm.

The solid electrolyte layer 30 may be positioned between the cathode layer 10 and the anode current collector 20 so as to allow lithium ions to move therebetween.

The solid electrolyte layer 30 may include an oxide-based solid electrolyte or a sulfide-based solid electrolyte. In certain examples, the sulfide-based solid electrolyte has a high lithium-ion conductivity. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one of germanium (Ge), zinc (Zn), and gallium (Ga)), Li₂S—GeS₂, Li₂S—SiS₂—Li₃PO₄, Li₂S—SiS₂—LiₓMO_{y} (in which x and y are positive numbers and M is any one of phosphorous (P), silicon (Si), germanium (Ge), boron (B), aluminum (Al), gallium (Ga), and indium (In)), Li₁₀GeP₂S₁₂, and the like.

The oxide-based solid electrolyte or sulfide-based solid electrolyte included in the solid electrolyte layer 30 may be the same as or different from the oxide-based solid electrolyte or sulfide-based solid electrolyte included in the cathode layer 10.

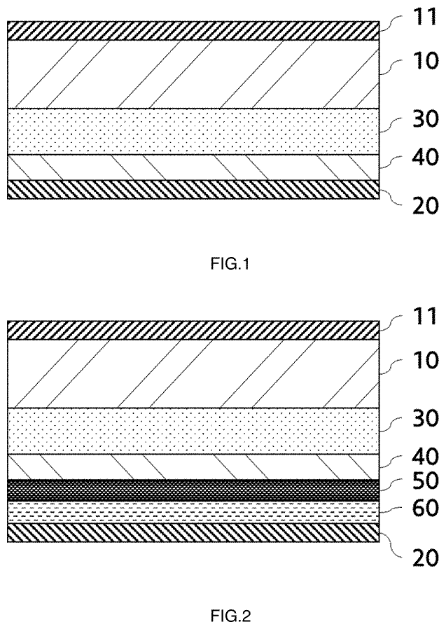

The protective layer 40 may include a metal sulfide incapable of alloying with lithium and a metal capable of alloying with lithium. The metal sulfide fills a space between the anode current collector 20 and the solid electrolyte layer 30 and is responsible for moving lithium ions therebetween. During charging of the all-solid-state battery, lithium ions, which are introduced into the protective layer 40 from the solid electrolyte layer 30, move through the metal sulfide and react with the metal capable of alloying with lithium. Accordingly, as shown in FIG. 2, a lithium storage layer 50 including Li/metal-sulfide/metal is formed. Moreover, lithium ions, which are continuously introduced, are deposited between the lithium storage layer 50 and the anode current collector 20 to form a lithium deposition layer 60.

The metal sulfide may include a compound represented by Chemical Formula 1 below.

[Chemical Formula 1]

MSₓ (1)

Here, M includes molybdenum (Mo), tungsten (W), chromium (Cr), vanadium (V), titanium (Ti), manganese (Mn), iron (Fe), cobalt (Co), nickel (Ni), copper (Cu), or any combination thereof, and x is an integer in a range of 1 to 3.

Specifically, the metal sulfide may include MoS₂, WS₂, CoS₂, NiS, or any combination thereof.

The average particle diameter (D50) of the metal sulfide may range from 10 nm to 500 nm.

The metal may include silver (Ag), tin (Sₙ), zinc (Zn), magnesium (Mg), indium (In), bismuth (Bi), germanium (Ge), silicon (Si), or any combination thereof.

The average particle diameter (D50) of the metal may range from 10 nm to 500 nm.

The protective layer 40 may include 20 wt. % to 90 wt. % of the metal sulfide and 10 wt. % to 80 wt. % of the metal. In other example, the protective layer 40 may include 50 wt. % to 90 wt. % of the metal sulfide and 10 wt. % to 50 wt. % of the metal. In yet another example, the protective layer 40 may include 70 wt. % to 90 wt. % of the metal sulfide and 10 wt. % to 30 wt. % of the metal. When the amounts of the metal sulfide and the metal fall within the above ranges, the growth of lithium dendrites may be suppressed and characteristics such as lifespan and the like may be improved.

The protective layer 40 may further include a small amount of a binder. The binder may include at least one of butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), polyethylene oxide (PEO), or any combination thereof.

The protective layer 40 may include the binder in an amount of 1 part by weight to 20 parts by weight based on 100 parts by weight, which is the sum of the metal sulfide and the metal.

The protective layer 40 does not include a carbon material. This is in contrast with a conventional anodeless all-solid-state battery, which uses a carbon material in order to provide space for lithium deposition. In the present disclosure, a metal sulfide advantageously provides the path of movement of lithium ions in the protective layer 40, so reversible charge and discharge is possible without using a carbon material.

The thickness of the coating layer 40 may range from 0.1 μm to 20 μm. If the thickness of the coating layer 40 is less than 0.1 μm, the effects described above cannot be obtained due to the insufficient amounts of the metal sulfide and metal. Further, if the thickness of the coating layer 40 exceeds 20 μm, reversible charge and discharge may become difficult because the coating layer is too thick.

In addition, a method of manufacturing the all-solid-state battery may include preparing a slurry including a metal sulfide incapable of alloying with lithium, a metal capable of alloying with lithium, and a solvent; forming a protective layer by applying the slurry on an anode current collector; forming a solid electrolyte layer on the protective layer; and forming a cathode layer on the solid electrolyte layer.

The solvent is not particularly limited, and any solvent may be used, so long as it is capable of dispersing the metal sulfide, the metal, and the binder. For example, the solvent may include N-methyl pyrrolidone (NMP), water, ethanol, isopropanol, dimethyl sulfoxide (DMSO), or any combination thereof.

The slurry may further include a binder. The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), polyethylene oxide (PEO), or any combination thereof.

The slurry may include the binder in an amount of 1 part by weight to 20 parts by weight based on 100 parts by weight, which is the sum of the metal sulfide and the metal.

The solid electrolyte layer may be formed using a slurry including a solid electrolyte or by pressing a solid electrolyte in a powder phase. Moreover, the cathode layer may be formed using a slurry including a cathode active material or by pressing starting materials in a powder phase.

The acts of forming the coating layer, the solid electrolyte layer, and the cathode layer are not necessarily performed in the order in which they are mentioned, and individual layers may be formed at the same time or at different times. Moreover, variations in the manufacturing method described above may encompass not only directly forming a solid electrolyte layer on the coating layer, a cathode layer on the solid electrolyte layer, and a cathode current collector on the cathode layer, but also forming the individual layers separately and then stacking the same to realize the structure shown in FIG. 1.

A better understanding of the present disclosure may be obtained through the following examples. However, these examples are merely set forth to illustrate the present disclosure and are not to be construed as limiting the scope of the present disclosure.

### COMPARATIVE EXAMPLE

A protective layer including a metal sulfide was formed. A slurry was prepared by adding MoS₂ (D50: 80 nm), which is the metal sulfide, to an NMP (N-methyl pyrrolidone), which is a solvent, and adding a small amount of a PVDF (polyvinylidene difluoride), which is a binder, thereto.

A protective layer was formed by applying the slurry on an anode current collector.

A half-cell was manufactured by forming a solid electrolyte layer on the protective layer and attaching a lithium thin film to the upper surface of the solid electrolyte layer.

The battery characteristics were evaluated by charging and discharging the half cell. Specifically, evaluation was carried out under conditions of a current density of 1.175 mA/cm² and a deposition capacity of 3.52 mAh/cm². The evaluation temperature was set to 60° C. Efficiency was determined by measuring the magnitude of charge after discharge for a predetermined period of time.

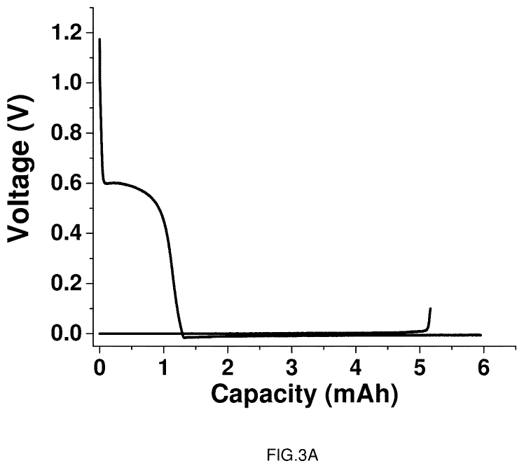

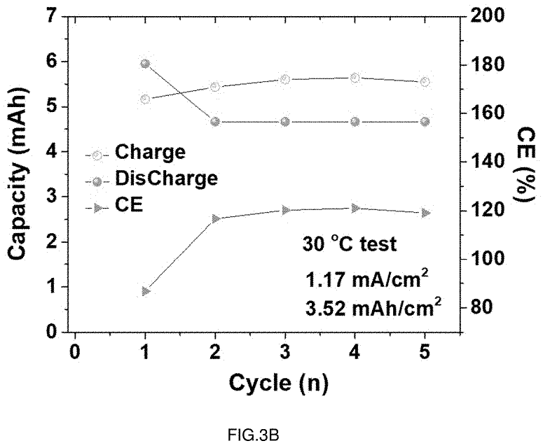

FIG. 3A shows a first charge/discharge graph of the half-cell according to Comparative Example. With reference thereto, open-circuit voltage (OCV) is 2 V, and a capacity of 1.0 mAh or more was exhibited at 0.6 V during the first discharge. This indicates the electrochemical decomposition of MoS₂, based on which it can be confirmed that the movement of lithium ions in MoS₂ is possible.

FIG. 3B shows the results of evaluation of the lifespan of the half-cell according to Comparative Example. With reference thereto, an abnormal phenomenon in which the magnitude of charge was greater than the magnitude of discharge was observed from the second cycle. This is a phenomenon that occurs when lithium dendrites are formed on the protective layer. Because MoS₂ is capable of conducting lithium ions but has no lithium affinity, it was found that uniform lithium deposition is impossible.

### Example 1

A slurry was prepared by adding MoS₂ (D50: 80 nm) as a metal sulfide and Ag (D50: 50 nm) as a metal to an NMP (N-methyl pyrrolidone), which is a solvent, and adding a small amount of a PVDF (polyvinylidene difluoride), which is a binder, thereto. The slurry includes 70 wt. % of the metal sulfide and 30 wt. % of the metal, excluding the binder.

A protective layer was formed by applying the slurry on an anode current collector.

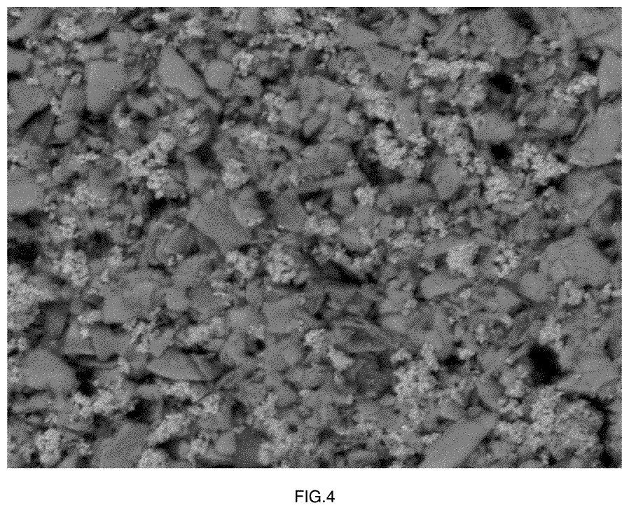

FIG. 4 shows an SEM image of the surface of the protective layer.

A half-cell was manufactured by forming a solid electrolyte layer on the protective layer and attaching a lithium thin film to the upper surface of the solid electrolyte layer.

The battery characteristics were evaluated by charging and discharging the half cell. Specifically, evaluation was carried out under conditions of a current density of 1.175 mA/cm² and a deposition capacity of 3.52 mAh/cm². The evaluation temperature was set to 60° C. Efficiency was determined by measuring the magnitude of charge after discharge for a predetermined period of time.

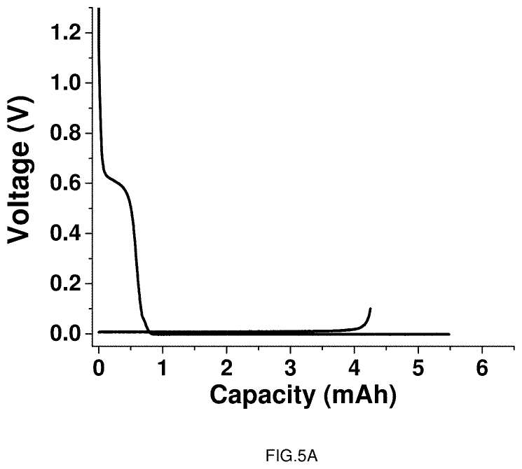

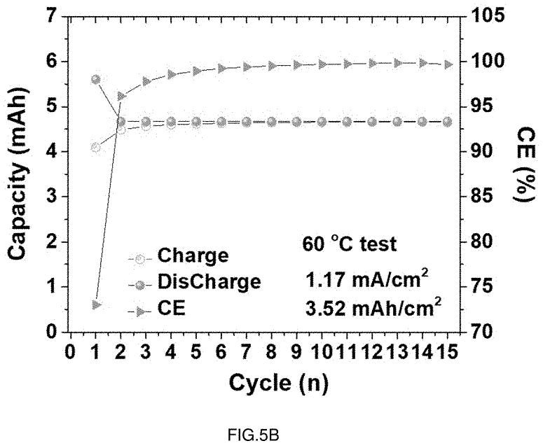

FIG. 5A shows a first charge/discharge graph of the half-cell according to Example 1. With reference thereto, the half-cell exhibited a capacity at 0.6 V during discharge, which is due to the conversion reaction between MoS₂ and lithium ions. Ag did not affect the electrochemical conversion reaction of MoS₂.

FIG. 5B shows the results of evaluation of the lifespan of the half-cell according to Example 1. With reference thereto, the half-cell was stably driven for 15 cycles, unlike Comparative Example, and the efficiency thereof was 99% or more in the 15^{th} cycle. Therefore, it was confirmed that an all-solid-state battery, which enables stable charge and discharge by introducing a metal capable of alloying with lithium, can be obtained.

### Example 2

The battery characteristics were evaluated by charging and discharging the half-cell of Example 1 at an evaluation temperature of 30° C.

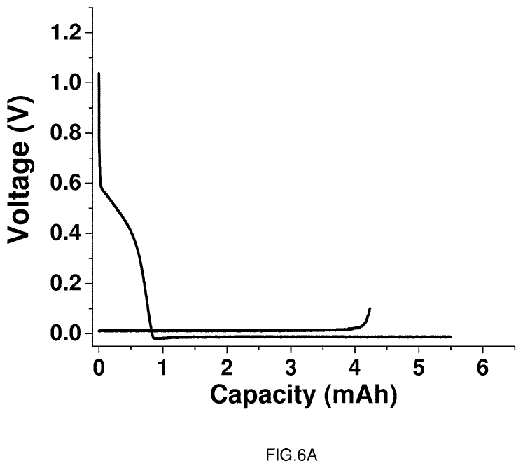

FIG. 6A shows a first charge/discharge graph of the half-cell according to Example 2. With reference thereto, a reversible capacity of 0.8 mAh was exhibited up to 0 V during the first discharge. This means that the electrochemical conversion reaction of MoS₂ is possible even at room temperature.

FIG. 6B shows the results of evaluation of the lifespan of the half-cell according to Example 2. With reference thereto, the half-cell was stably charged and discharged for 20 cycles, and the efficiency thereof was 99% or more in the 20^{th} cycle, indicating that the function of the protective layer of the half-cell was maintained even at room temperature.

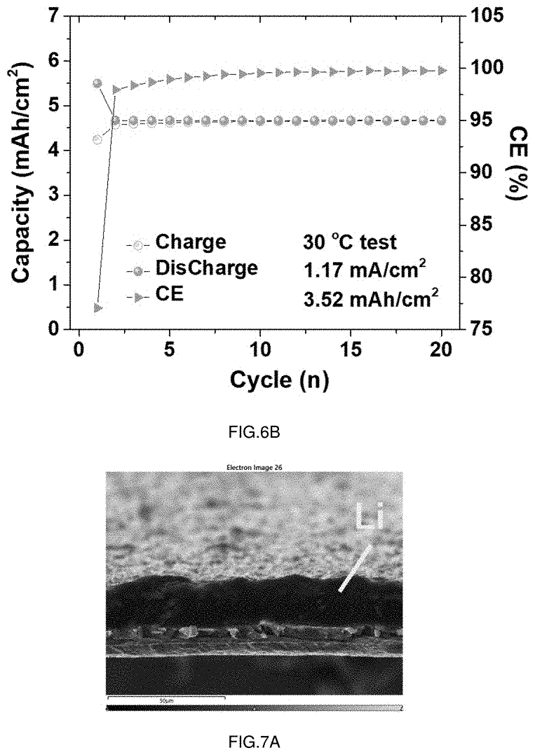

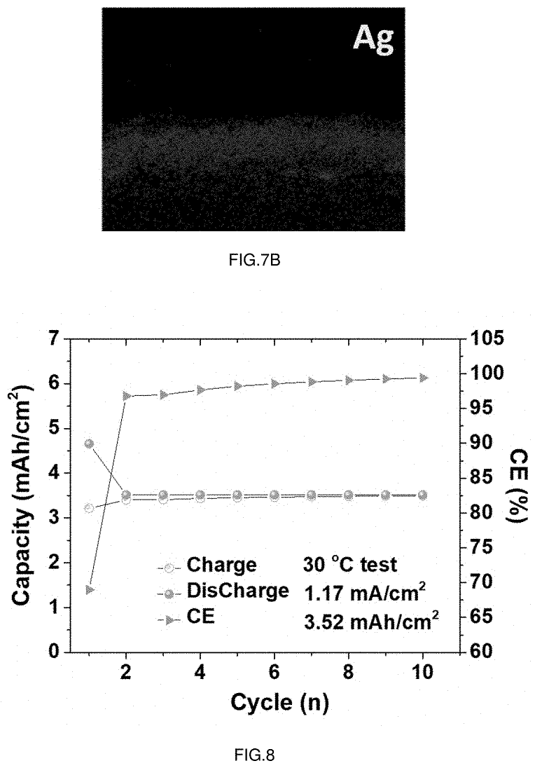

FIG. 7A shows an electron microscope image of the cross section of the half-cell according to Example 2 after being charged the first time. FIG. 7B shows the results of energy dispersive X-ray spectroscopy (EDS) of the cross section of FIG. 7A. With reference to FIG. 7A, it can be seen that lithium was uniformly formed on the anode current collector. Silver (Ag) is doped into lithium to help trace the lithium storage layer. Thereby, it was found that Ag induces uniform lithium deposition and also that MoS₂ enables efficient movement of lithium ions between the anode current collector and the solid electrolyte layer.

### Example 3

A protective layer and a half cell were manufactured in the same manner as in Example 1, with the exception that 90 wt. % metal sulfide and 10 wt. % metal were used. The battery characteristics were evaluated through charge and discharge under the same conditions as Example 2 (an evaluation temperature of 30° C.).

FIG. 8 shows the results of evaluation of the lifespan of the half-cell according to Example 3. With reference thereto, it was confirmed that the half-cell is driven even when the amount of the metal is decreased to 10 wt. %.

As is apparent from the above description, an all-solid-state battery capable of suppressing the formation of lithium dendrites can be obtained.

According to the present disclosure, an all-solid-state battery having improved battery characteristics such as lifespan, charge/discharge rate, and the like can be obtained.

According to the present disclosure, an all-solid-state battery capable of operating across a wide temperature range from low to high temperatures can be obtained.

The effects of the present disclosure are not limited to the above-mentioned effects. It should be understood that the effects of the present disclosure include all effects that can be inferred from the description of the present disclosure.

As described hereinbefore, the present disclosure has been described in detail with reference to test examples and embodiments. However, the scope of the present disclosure is not limited to the aforementioned test examples and examples, and various modifications and improved modes of the present disclosure using the basic concept of the present disclosure defined in the accompanying claims are also incorporated in the scope of the present disclosure.

What is claimed is:

1. An all-solid-state battery comprising:
a cathode layer;
an anode current collector;
a solid electrolyte layer interposed between the cathode layer and the anode current collector; and
a protective layer interposed between the anode current collector and the solid electrolyte layer,
wherein the protective layer comprises a metal.

2. The all-solid-state battery of claim 1, wherein the metal of the protective layer is capable of alloying with lithium, and
wherein the protective layer further comprises a metal sulfide incapable of alloying with lithium.

3. The all-solid-state battery of claim 2, wherein the metal sulfide comprises a compound represented by chemical formula MSₓ,
wherein M comprises molybdenum (Mo), tungsten (W), chromium (Cr), vanadium (V), titanium (Ti), manganese (Mn), iron (Fe), cobalt (Co), nickel (Ni), copper (Cu), or any combination thereof, and
wherein x is an integer in a range of 1 to 3.

4. The all-solid-state battery of claim 2, wherein an average particle diameter (D50) of the metal sulfide is in a range of 10 nm to 500 nm.

5. The all-solid-state battery of claim 2, wherein the protective layer comprises:
wt. % to 90 wt. % of the metal sulfide; and
wt. % to 80 wt. % of the metal.

6. The all-solid-state battery of claim 2, wherein the protective layer further comprises a binder.

7. The all-solid-state battery of claim 6, wherein the binder comprises butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), polyethylene oxide (PEO), or a combination thereof.

8. The all-solid-state battery of claim 6, wherein the protective layer comprises 1 part by weight to 20 parts by weight of the binder based on 100 parts by weight of the metal sulfide and the metal.

9. The all-solid-state battery of claim 1, wherein the metal comprises silver (Ag), tin (Sₙ), zinc (Zn), magnesium (Mg), indium (In), bismuth (Bi), germanium (Ge), silicon (Si), or any combination thereof.

10. The all-solid-state battery of claim 1, wherein an average particle diameter (D50) of the metal is in a range of 10 nm to 500 nm.

11. The all-solid-state battery of claim 1, wherein the protective layer has a thickness in a range of 0.1 μm to 20 μm.

12. A method of manufacturing an all-solid-state battery, the method comprising:
preparing a slurry comprising a metal sulfide incapable of alloying with lithium, a metal capable of alloying with lithium, and a solvent;
forming a protective layer by applying the slurry on an anode current collector;
forming a solid electrolyte layer on the protective layer; and
forming a cathode layer on the solid electrolyte layer.

13. The method of claim 12, wherein the metal sulfide comprises a compound represented by chemical formula MSₓ,
wherein M comprises molybdenum (Mo), tungsten (W), chromium (Cr), vanadium (V), titanium (Ti), manganese (Mn), iron (Fe), cobalt (Co), nickel (Ni), copper (Cu), or any combination thereof, and
wherein x is an integer in a range of 1 to 3.

14. The method of claim 12, wherein an average particle diameter (D50) of the metal sulfide is in a range of 10 nm to 500 nm.

15. The method of claim 12, wherein the metal comprises silver (Ag), tin (Sₙ), zinc (Zn), magnesium (Mg), indium (In), bismuth (Bi), germanium (Ge), silicon (Si), or any combination thereof.

16. The method of claim 12, wherein an average particle diameter (D50) of the metal is in a range of 10 nm to 500 nm.

17. The method of claim 12, wherein the solvent comprises N-methyl pyrrolidone (NMP), water, ethanol, isopropanol, dimethyl sulfoxide (DMSO), or a combination thereof.

18. The method of claim 12, wherein the slurry further comprises a binder, and
wherein the binder comprises butadiene rubber (BR), nitrile butadiene rubber (NBR), hydrogenated nitrile butadiene rubber (HNBR), polyvinylidene difluoride (PVDF), polytetrafluoroethylene (PTFE), carboxymethyl cellulose (CMC), polyethylene oxide (PEO), or a combination thereof.

19. The method of claim 18, wherein the slurry comprises 1 part by weight to 20 parts by weight of the binder based on 100 parts by weight of the metal sulfide and the metal.

20. The method of claim 12, wherein the protective layer has a thickness is a range of 0.1 μm to 20 μm.
